(19) United States
(12) Patent Application Publication
(10) Pub. No.: US 2008/0310358 A1
(43) Pub. Date: Dec. 18, 2008

(54) METHOD AND APPARATUS FOR PROVIDING CELL INFORMATION LIST FOR NON-3GPP CAPABLE USER EQUIPMENT OPERATING IN A 3GPP NETWORK AND SUPPORTING LAYER-2 BASED HANDOFF FROM A UTRAN SYSTEM TO A NON-3GPP SYSTEM

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/132,314

(22) Filed: Jun. 3, 2008

Related U.S. Application Data
(60) Provisional application No. 60/942,286, filed on Jun. 6, 2007.
(60) Provisional application No. 60/942,674, filed on Jun. 8, 2007.

(51) Int. Cl. H04Q 7/00

(52) U.S. Cl. 370/329

(57) ABSTRACT

Method and apparatus providing cell information list for non-third generation partnership project (3GPP) capable wireless transmitter/receiver unit (WTRU) operating in a 3GPP network, which camps on a 3GPP channel to obtain information of at least one network available in the cell. The WTRU may request a list having at least one of a trusted IEEE 802.11 network, a non-trusted IEEE 802.11 network, a trusted WiMAX network, and a fixed broadband network. In an inter radio access technology (RAT) procedure for an inter-RAT handover, a list of available systems and at least one of intra-frequency, inter-frequency, and inter-radio access technology (RAT) cells is received and stored while the WTRU is engaged in a call. While moving, the WTRU detects and performs radio frequency (RF) measurements on target cells and systems and reports inter-RAT handover information. Upon receipt of a command, the WTRU initiates a handover, followed by a complete message.

### CROSS REFERENCE TO RELATED APPLICATIONS

This application claims the benefit of U.S. Provisional Application No. 60/942,286, filed Jun. 6, 2007 and U.S. Provisional Application No. 60/942,674, filed Jun. 8, 2007, which are incorporated by reference as if fully set forth.

### FIELD OF INVENTION

The present invention is related to wireless communication systems.

### BACKGROUND

Currently the mobile communication industry is moving toward convergence and interworking between various wireless technologies, (e.g., 3^{rd} Generation Partnership Project-based (3GPP-based), 3GPP2-based, WiFi 802.11, WiMAx 802.16, and Fixed Broadband Access). The main purpose is to allow a subscriber to access home-based services anywhere and via any technology. In order to support this objective, the industry standards in 3GPP have defined the interworking architecture between the home public land mobile network (HPLMN) and the non-3GPP networks, as shown in FIG. 1. For such operation to be achieved effectively, various information describing these different systems has to be provided over the 3GPP network for mobile units operating in such technology (general packet radio services (GPRS), universal mobile telecommunication system (UMTS), and/or long term evolution (LTE)).

The following interfaces are shown in FIG. 1, except as otherwise noted.
S1 Mobility Management Entity (MME) S1-MME, S1-U, S3, S4, S10 S11 are defined in 3GPP in TS 23.401.
S2a: Provides the user plane with related control and mobility support between trusted non-3GPP Internet protocol (IP) access and the Packet Data Network (PDN) Gateway (GW).
S2b: Provides the user plane with related control and mobility support between the evolved packet data gateway (ePDG) and the PDN GW.
S2c: Provides the user plane with related control and mobility support between WTRU and the PDN GW. This reference point is implemented over trusted and/or untrusted non-3GPP Access and/or 3GPP access. The portion of S2c extending through the “ACCESS” oval is shown dotted to indicate a direct connection between the PDN GW and the WTRU.
S5: Provides user plane tunneling and tunnel management between the Serving Gateway (GW) and PDN GW and is used for Serving GW relocation due to WTRU mobility and in case the Serving GW needs to connect to a non co-located PDN GW for the required PDN connectivity.
S6a: This interface is defined between the MME and the Home Subscriber Server (HSS) for authentication and authorization and is defined in TS 23.401.
S6c: Is the reference point between the PDN GW in the HPLMN and the 3GPP authentication, authorization and accounting (AAA) server for mobility related authentication, if needed. This reference point may also be used to retrieve and request storage of mobility parameters.
S7: Provides transfer of Quality of Service (QoS) policy and charging rules from the Policy and Charging Rules Function (PCRF) to a Policy and Charging Enforcement Point (PCEF). PCEF was previously part of the GGSN. However, in LTE, it is a separate function box which may be implemented separately and is therefore not shown in FIG. 1 for purposes of simplicity.
S8b: Is the roaming interface in case of roaming with home routed traffic and provides the user plane with related control between Gateways in the VPLMN and HPLMN. S8b is not relevant to the embodiments set forth herein and has been omitted from FIG. 1 for purposes of simplicity.
S9: Indicates the roaming variant of the S7 reference point for the enforcement in the VPLMN of dynamic control policies from the HPLMN. S9 is not relevant to the embodiments set forth herein and has been omitted from FIG. 1 for purposes of simplicity.
SGi: Is the reference point between the PDN GW and the PDN. The Packet data network may be an operator external public or private PDN or an intra-operator PDN, e.g. for provision of IP multi-media subsystem (IMS) services. This reference point corresponds to Gi and Wi functionalities and supports any 3GPP and non-3GPP access system.
Wa: Connects the Untrusted non-3GPP IP Access with the 3GPP AAA Server/Proxy and transports access, authentication, authorization and charging-related information in a secure manner.
Ta: Connects the Trusted non-3GPP IP Access with the 3GPP AAA Server/Proxy and transports access, authentication, authorization, mobility parameters and charging-related information in a secure manner.
Wd: Connects the 3GPP AAA Proxy, possibly via intermediate networks, to the 3GPP AAA Server. Differences are compared to Wd. Wd is not relevant to the embodiments set forth herein and has been omitted from FIG. 1 for purposes of simplicity.
Wm: This reference point is located between 3GPP AAA Server/Proxy and the ePDG and is used for AAA signaling (transport of mobility parameters, tunnel authentication and authorization data). Differences are compared to Wm.
Wn: Is the reference point between the Untrusted Non-3GPP IP Access and the ePDG. Traffic on this interface for a WTRU-initiated tunnel has to be forced towards ePDG. The existence of an entity corresponding to WAG in I-WLAN and its impact on Wn* is FFS.
Wx: This reference point is located between 3GPP AAA Server and the HSS, the database for subscriber information and is used for transport of authentication data.
RX+ Is an IP-based interface between the PCRF and IMS to provide policies and Policy decisions to Multimedia-based decisions.
The S1 interface for e-UTRAN is the same for both Roaming and Non-Roaming architectures.

It should be noted that all untrusted non-3GPP access, see terms marked with an asterisk (*) in FIG. 1, requires an ePDG interface.

Protocol assumptions for handoff are as follows:
S2a interface and S2b interface are based on current or future Internet Engineering Task Force (IETF) Request For Comments (RFCs). S2a is based on Proxy Mobile IP (PMIP). To enable access via Trusted Non-3GPP IP accesses that do not support PMIP, S2a also supports the Client Mobile IPv4 Foreign Agent (IPv4 FA) mode. S2b is based on PMIP.
S2c is based on the Client Mobile IP co-located mode. (The exact protocol decision is for further study (FFS))
The S5, S8b and S2a/S2b interfaces described above are based on the same protocols and differences shall be minimized. The S5 interface is based on current or future IETF RFCs. The GPRS Tunneling Protocol (GTP) variant of the S5 interface is described in TS 23.401.
The S8b interface is based on current or future IETF RFCs. The GTP variant interface (S8a) is described in TS 23.401.

The Evolved Packet System (EPS) shall allow the operator to configure a type of access (3GPP or non-3GPP) as the “home link” for Client Mobile IP purposes. Redundancy support on reference points S5 and S8b should be taken into account.

FIG. 2, in addition to providing a capability according to one of the embodiments herein, also includes a conventional process for providing a cell information list. Upon power up of a WTRU, the WTRU, at step S1, camps on a 3GPP control channel. The WTRU receives and stores the list of available systems, (e.g., global standards for mobile communication (GSM), GPRS, UMTS, CDMA2000) within the cell of a system, at S2. The WTRU camps on the 3GPP system at S3. According to one embodiment the WTRU, at S4, may request the network for additional information regarding supported systems. The 3GPP system, at S5, may respond with a list of other networks available, i.e., the non-3GPP networks.

The Handover Commands presently in use are set forth below.

Existing Handover Commands in TS 23.331:

10.2.16b Handover to UTRAN Command

This message, as set forth below, is sent to the WTRU via another system for a handover to the UTRAN.

Radio Link Control-Service Access Point (RLC-SAP): N/A (Sent through a different Radio Access Technology (RAT))

Logical channel: N/A (Sent through a different RAT)

Direction: UTRAN→WTRU

| Information | | | Type and | Semantics |
|---|---|---|---|---|
| Element/Group name | Need | Multi | reference | description |
| New U-RNTI | MP | | U-RNTI | |
| | | | Short | |
| | | | 10.3.3.48 | |
| Ciphering algorithm | OP | | Ciphering | |
| | | | algorithm | |
| | | | 10.3.3.4 | |
| CHOICE specification mode | MP | | | |
| Complete specification | | | | |
| RB information elements | | | | |
| Signalling RB information | MP | 1 to | | For each signalling radio |
| to setup list | | <maxSRBsetup> | | bearer established |
| Signalling RB information | MP | | Signalling | |
| to setup | | | RB | |
| | | | information | |
| | | | to setup | |
| | | | 10.3.4.24 | |
| RAB information to setup | OP | 1 to | | For each RAB |
| list | | <maxRABsetup> | | established |
| RAB information for setup | MP | | RAB | |
| | | | information | |
| | | | for setup | |
| | | | 10.3.4.10 | |
| Uplink transport channels | | | | |
| UL Transport channel | MP | | UL | |
| information common for all | | | Transport | |
| transport channels | | | channel | |
| | | | information | |
| | | | common for | |
| | | | all | |
| | | | transport | |
| | | | channels | |
| | | | 10.3.5.24 | |
| Added or Reconfigured | MP | 1 to | | |
| TrCH information | | <maxTrCH> | | |
| Added or Reconfigured UL | MP | | Added or | |
| TrCH information | | | Reconfigured | |
| | | | UL TrCH | |
| | | | information | |
| | | | 10.3.5.2 | |
| Downlink transport | | | | |
| channels | | | | |
| DL Transport channel | MP | | DL | |
| information common for all | | | Transport | |
| transport channels | | | channel | |
| | | | information | |
| | | | common for | |
| | | | all | |
| | | | transport | |
| | | | channels | |
| | | | 10.3.5.6 | |
| Added or Reconfigured | MP | 1 to | | |
| TrCH information | | <maxTrCH> | | |
| Added or Reconfigured DL | MP | | Added or | |
| TrCH information | | | Reconfigured | |
| | | | DL TrCH | |
| | | | information | |
| | | | 10.3.5.1 | |
| Uplink radio resources | | | | |
| Uplink DPCH info | MP | | Uplink | |
| | | | DPCH info | |
| | | | 10.3.6.88 | |
| CHOICE mode | MP | | | |
| FDD | | | | |
| Common Power Control | OP | | CPCH SET | |
| Channel (CPCH) SET Info | | | Info | |
| | | | 10.3.6.13 | |
| Downlink radio resources | | | | |
| Downlink Physical | OP | | Downlink | |
| Downlink Shared Channel | | | PDSCH | |
| (PDSCH) information | | | information | |
| | | | 10.3.6.30 | |
| TDD | | | | (no data) |
| Downlink information | MP | | Downlink | |
| common for all radio links | | | information | |
| | | | common for | |
| | | | all radio | |
| | | | links | |
| | | | 10.3.6.24 | |
| Downlink information per | MP | 1 to | | |
| radio link | | <maxRL> | | |
| Downlink information for | MP | | Downlink | |
| each radio link | | | information | |
| | | | for each | |
| | | | radio link | |
| | | | 10.3.6.27 | |
| Preconfiguration | | | | |
| CHOICE Preconfiguration | MP | | | |
| mode | | | | |
| Predefined configuration | MP | | Predefined | |
| | | | configuration | |
| | | | identity | |
| | | | 10.3.4.5 | |
| Default configuration | | | | |
| Default configuration | MP | | Enumerated | Indicates whether the |
| mode | | | (FDD, | FDD or TDD version of |
| | | | TDD) | the default configuration |
| | | | | shall be used |
| Default configuration | MP | | Default | |
| identity | | | configuration | |
| | | | identity | |
| | | | 10.3.4.0 | |
| Radio Access Bearer (RAB) | OP | | RAB info | One RAB is established |
| info | | | Post | |
| | | | 10.3.4.9 | |
| Uplink DPCH info | MP | | Uplink | |
| | | | DPCH info | |
| | | | Post | |
| | | | 10.3.6.89 | |
| Downlink radio resources | | | | |
| Downlink information | MP | | Downlink | |
| common for all radio links | | | information | |
| | | | common for | |
| | | | all radio | |
| | | | links Post | |
| | | | 10.3.6.25 | |
| Downlink information per | MP | 1 to | | Send downlink |
| radio link | | <maxRL> | | information for each |
| | | | | radio link to be set-up. |
| | | | | In TDD MaxRL is 1. |
| Downlink information for | MP | | Downlink | |
| each radio link | | | information | |
| | | | for each | |
| | | | radio link | |
| | | | Post | |
| | | | 10.3.6.28 | |
| CHOICE mode | MP | | | |
| FDD | | | | (no data) |
| TDD | | | | |
| Primary (Common | MP | | Primary | |
| Control Physical Channel | | | CCPCH Tx | |
| (CCPCH) Tx Power | | | Power | |
| | | | 10.3.6.59 | |
| Frequency info | MP | | Frequency | |
| | | | info | |
| | | | 10.3.6.36 | |
| Maximum allowed UL TX | MP | | Maximum | |
| power | | | allowed UL | |
| | | | TX power | |
| | | | 10.3.6.39 | |

10.2.16b Handover to UTRAN Complete

This message, as set forth below, is sent by the WTRU when a handover to UTRAN has been completed.

RLC-SAP: Acknowledge Mode (AM)

Logical channel: Dedicated Control Channel (DCCH)

Direction: WTRU→UTRAN

| Information | | | Type and | |
|---|---|---|---|---|
| Element/Group name | Need | Multi | reference | Semantics description |
| Message Type | MP | | Message | |
| | | | Type | |
| WTRU Information | | | | |
| elements | | | | |
| START list | Channel | 1 to | | START [40] values for all |
| | (CH) | <maxCNdomains> | | Core Network (CN) |
| | | | | domains. |
| CN domain identity | MP | | CN domain | |
| | | | identity | |
| | | | 10.3.1.1 | |
| START | MP | | START | |
| | | | 10.3.3.38 | |
| Radio Bearer (RB) | | | | |
| Information elements | | | | |
| COUNT-C activation time | OP | | Activation | Used for radio bearers |
| | | | time | mapped on RLC-TM. |
| | | | 10.3.3.1 | |

10.2.16c Initial Direct Transfer

This message, as set forth below, is used to initiate a signaling connection based on an indication from the upper layers, and to transfer a Network Access Server (NAS) message.

RLC-SAP: AM

Logical channel: DCCH

Direction: WTRU->UTRAN

| Information | | | Type and | Semantics | |
|---|---|---|---|---|---|
| Element/Group name | Need | Multi | reference | description | Version |
| Message Type | MP | | Message | | |
| | | | Type | | |
| WTRU information | | | | | |
| elements | | | | | |
| Integrity check info | CH | | Integrity | | |
| | | | check info | | |
| | | | 10.3.3.16 | | |
| PLMN identity | OP | | PLMN | This IE indicates the | REL-6 |
| | | | identity | PLMN to which the | |
| | | | 10.3.1.11 | WRTU requests the | |
| | | | | signalling connection | |
| | | | | to be established. | |
| CN information | | | | | |
| elements | | | | | |
| CN domain identity | MP | | CN domain | | |
| | | | identity | | |
| | | | 10.3.1.1 | | |
| Intra Domain NAS | MP | | Intra | | |
| Node Selector | | | Domain | | |
| | | | NAS Node | | |
| | | | Selector | | |
| | | | 10.3.1.6 | | |
| NAS message | MP | | NAS | | |
| | | | message | | |
| | | | 10.3.1.8 | | |
| START | OP | | START | START value to be | |
| | | | 10.3.3.38 | used in the CN | |
| | | | | domain as indicated | |
| | | | | in the IE “CN | |
| | | | | domain identity”. | |
| | | | | This IE shall always | |
| | | | | be present in this | |
| | | | | version of the | |
| | | | | protocol. | |
| Establishment cause | OP | | Establishment | | Rel-5 |
| | | | cause | | |
| | | | 10.3.3.11 | | |
| Measurement | | | | | |
| information elements | | | | | |
| Measured results on | OP | | Measured | | |
| Random Access | | | results on | | |
| Channel (RACH) | | | RACH | | |
| | | | 10.3.7.45 | | |
| MBMS joined | OP | | | | REL-6 |
| information | | | | | |
| >Packet-Temporary | OP | | P-TMSI | | REL-6 |
| Mobile Subscriber | | | (GSM- | | |
| Identity (P-TMSI) | | | MAP) | | |
| | | | 10.3.1.13 | | |

Existing Inter RAT Handover Information/Commands in TS 23.331:

10.2.16d Inter RAT Handover Information

This message, as set forth below, is sent by the WTRU via another RAT to provide information to the target RNC when preparing for a handover to the UTRAN.

RLC-SAP: N/A (Sent through a different RAT)

Logical channel: N/A (Sent through a different RAT)

Direction: WTRU→UTRAN

| Information | | | Type and | Semantics | |
|---|---|---|---|---|---|
| Element/Group Name | Need | Multi | reference | description | Version |
| Radio Bearer IEs | | | | | |
| Predefined | OP | | Predefined | | |
| configuration status | | | configuration | | |
| information | | | status | | |
| | | | information | | |
| | | | 10.3.4.5a | | |
| Predefined | OP | | Predefined | | REL-5 |
| configuration status | | | configuration | | |
| information compressed | | | status | | |
| | | | information | | |
| | | | compressed | | |
| | | | 10.3.4.5b | | |
| WTRU Information | | | | | |
| elements | | | | | |
| WTRU security | OP | | WTRU | | |
| information | | | security | | |
| | | | information | | |
| | | | 10.3.3.42b | | |
| >WTRU Specific | OP | | WTRU | This IE shall not be | |
| Behaviour Information | | | Specific | included in this | |
| 1 interRAT | | | Behaviour | version of the protocol | |
| | | | Information | | |
| | | | 1 interRAT | | |
| | | | 10.3.3.52 | | |
| WTRU capability | OP | | | | |
| container | | | | | |
| >WTRU radio access | MP | | WTRU | | |
| capability | | | radio access | | |
| | | | capability | | |
| | | | 10.3.3.42 | | |
| >WTRU radio access | MP | | WTRU | Although this IE is not | |
| capability extension | | | radio access | always required, the | |
| | | | capability | need has been set to | |
| | | | extension | MP to align with the | |
| | | | 10.3.3.42a | ASN.1 | |
| WTRU radio access | OP | | WTRU | | REL-5 |
| capability compressed | | | radio access | | |
| | | | capability | | |
| | | | compressed | | |
| | | | 10.3.3.42o | | |

### SUMMARY

A method and apparatus is disclosed for providing a cell information list for a non-3GPP capable WTRU operating in a 3GPP network. In a wireless communication system including a 3GPP network, the WTRU camps on a 3GPP control channel, and the 3GPP network provides information regarding at least one non-3GPP network available in the 3GPP network. The WTRU requests information, which may be a cell information list including cell information on at least one of intra-frequency, inter-frequency, and inter-radio access technology (inter-RAT) cells. The information list may also include at least one of a trusted IEEE 802.11 network information, a non-trusted IEEE 802.11 network information, a trusted WiMAX network information, and fixed broadband network information. Also provided is an inter-RAT procedure for performing an inter-RAT handover. The WTRU receives a broadcasted list and stores the list of available systems within a cell while engaged in a call. While moving, the WTRU detects and performs radio frequency (RF) measurements on target cells/systems and reports inter-RAT handover information to the systems and waits for directives. If a handoff command is received, handover procedures are initiated and a handover complete message is sent upon completion.

### BRIEF DESCRIPTION OF THE DRAWINGS

A more detailed understanding of the embodiments may be had from the following description, given by way of example and to be understood in conjunction with the accompanying drawings wherein:

FIG. 1 shows conventional interworking architecture.

FIG. 2 shows a process for providing a cell information list.

FIG. 3 shows existing operations used to perform handoff to a UTRAN system in 3GPP; and

FIG. 4 is a flow diagram of handoff procedures according to an embodiment described below and in addition to the existing operations obtainable through the related art shown in FIG. 3.

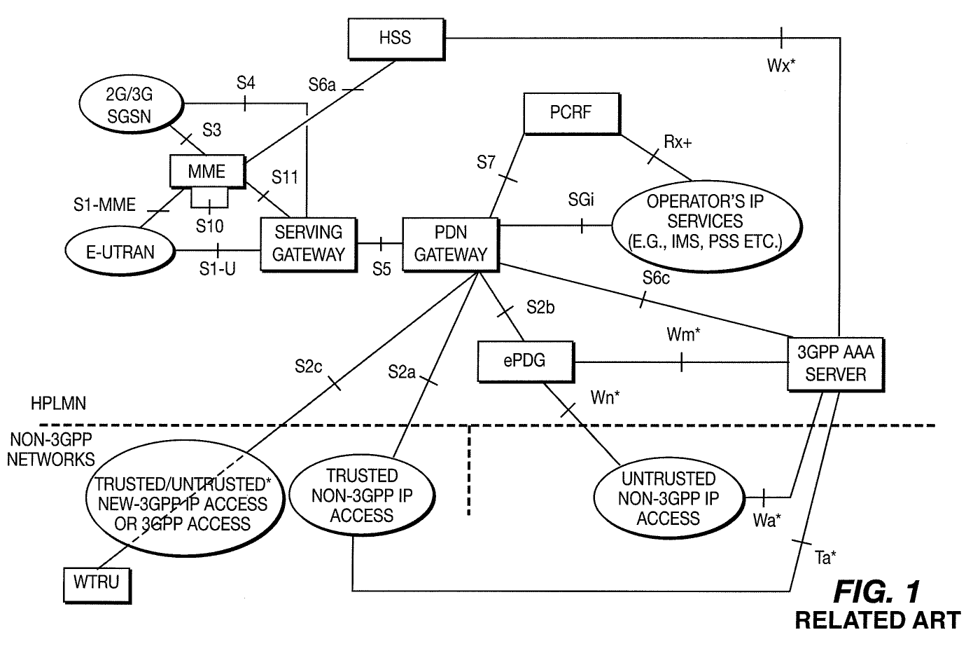

### DETAILED DESCRIPTION OF THE PREFERRED EMBODIMENTS

When referred to hereafter, the terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

Cell information not heretofore obtainable in presently existing systems is obtained in harmony with presently available information using an operation to download and update the network with the capabilities of a WTRU to support non-3GPP technologies as well as the various elements pertaining to these technologies defined in the 3GPP standard TS 25.331, employing the embodiments set forth herein. This expanded operation incorporates the non-3GPP technologies and networks in the cell information list defined in TS 25.331 to thereby facilitate interworking with non-3GPP technologies.

The CELL_INFO_LIST variable in TS 25.331 contains cell information on intra-frequency, inter-frequency and inter-radio access technology (RAT) cells, as received in messages System Information Block (SIB) Type 11, SIB Type 12, and MEASUREMENT CONTROL. The first position in the intra-frequency cell information list corresponds to intra-frequency cell identity (ID) 0, the second to intra-frequency cell ID 1, etc. The first position in the inter-frequency cell information list corresponds to inter-frequency cell ID 0, the second to inter-frequency cell ID 1, etc. The first position in an inter-RAT cell information list corresponds to inter-RAT cell ID 0, the second to inter-RAT cell ID 1, etc. This variable shall be cleared at cell re-selection, when leaving the universal terrestrial radio access (UTRA) radio resource control (RRC) connected mode, when switched off as well as at selection of a new public land mobile network (PLMN).

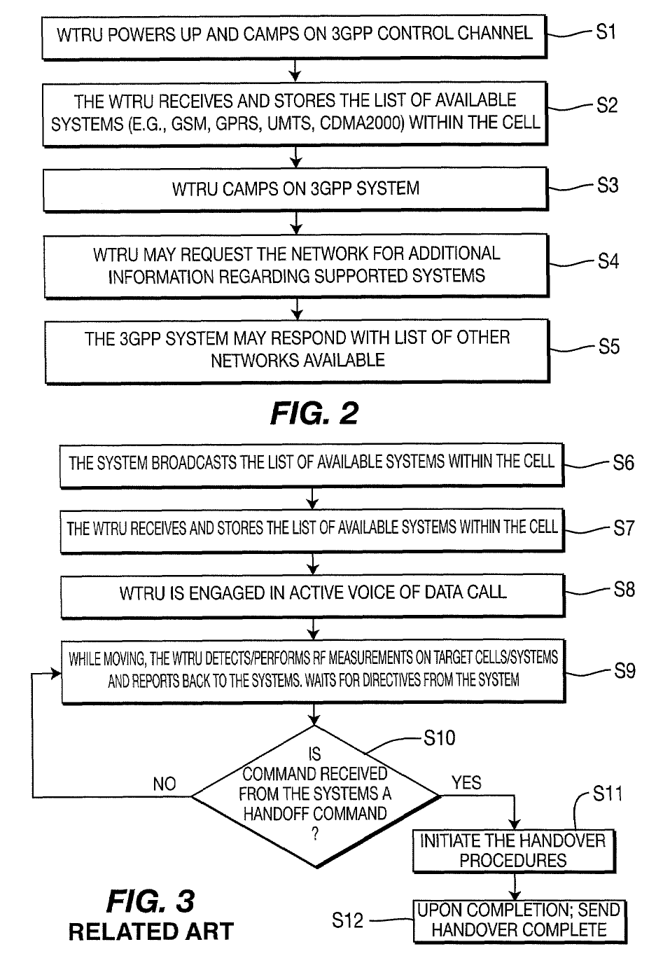

The following Table shows a cell information list with new information provided to the WTRU employing the method shown in FIG. 2. The new information which is obtained at step S5 in FIG. 2, is shown in bold.

| Information | | | Type and | |
|---|---|---|---|---|
| Element/Group name | Need | Multi | reference | Semantics description |
| Intra-frequency cell info | OP | 1 . . . <maxCellMeas> | | |
| CHOICE position status | MP | | | |
| Occupied | | | | |
| Cell info | MP | | Cell info | |
| | | | 10.3.7.2 | |
| Vacant | | | | No data |
| Inter-frequency cell info | OP | 1 . . . <maxCellMeas> | | |
| CHOICE position status | MP | | | |
| Occupied | | | | |
| Frequency info | MP | | Frequency info | |
| | | | 10.3.6.36 | |
| Cell info | MP | | Cell info | |
| | | | 10.3.7.2 | |
| Vacant | | | | No data |
| Inter-RAT cell info list | OP | | | |
| Inter-RAT cell info | OP | 1 . . . <maxCellMeas> | | |
| CHOICE position | MP | | | |
| status | | | | |
| Occupied | | | | |
| CHOICE Radio | | | | |
| Access Technology | | | | |
| GSM | | | | |
| Cell selection and | MP | | Cell selection | |
| re-selection info | | | and re-selection | |
| | | | info for SIB11/12 | |
| | | | 10.3.2.4 | |
| BSIC | MP | | BSIC 10.3.8.2 | |
| BCCH ARFCN | MP | | Integer (0 . . . 1023) | [3GPP TS 44.018] |
| IS-2000 | | | | |
| System specific | | | enumerated | For IS-2000, use fields |
| measurement info | | | (freq. timeslot, | from TIA/EIA/IS- |
| | | | colour code, | 2000.5, |
| | | | output power, | subclause 3. 7.3.3.2.27, |
| | | | PN offset) | Candidate Frequency |
| | | | | Neighbour List |
| | | | | Message |
| 802.11 Trusted | | | | |
| Wireless local | MP | | | |
| area network (WLAN) | | | | |
| selection and re- | | | | |
| selection info | | | | |
| Service set | MP | | | |
| identifier (SSID)/ | | | | |
| Operator Information | | | | |
| System Specific | MP | | enumerated | For 802.11 a b g n . . ., |
| measurement info | | | (frequency, | use fields from . . ., |
| | | | beacon, output | . . ., |
| | | | power) | |
| 802.11 Non- | | | | |
| Trusted | | | | |
| WLAN selection | MP | | | |
| and re-selection info | | | | |
| SSID/Operator | MP | | | |
| Information | | | | |
| System Specific | MP | | enumerated | For 802.11, a b g n . . . |
| measurement info | | | (frequency, | use fields from . . ., , |
| | | | beacon, output | |
| | | | power) | |
| WiMAX Trusted | | | | |
| WiMAX | MP | | | |
| selection and re- | | | | |
| selection info | | | | |
| SID/Operator | MP | | | |
| information | | | | |
| System Specific | MP | | enumerated | For 802.16, a e g use |
| measurement info | | | (frequency, | field from . . ., |
| | | | beacon, output | |
| | | | power) | |
| Fixed | | | | |
| Broadband | | | | |
| Fixed | MP | | | |
| Broadband selection | | | | |
| and re-selection info | | | | |
| Operator ID | MP | | | |
| System Specific | MP | | enumerated | |
| measurement info | | | (frequency, | |
| | | | beacon, output | |
| | | | power) | |

Note:
MP = Mandatory and OP = Optional.

FIG. 3 is a flow diagram showing a conventional handoff procedure. As shown in FIG. 3, a list of available systems is broadcast, at step S6. The WTRU, at S7, receives and stores the list of available systems within the cell. While engaged in active voice of a data call, S8, and while moving, at S9, the WTRU detects and performs RF measurements on target cells/systems and reports inter-RAT handover information to the systems and then waits for directives. If a handoff command is received, at S10, handover procedures are initiated at S11 and, upon completion, a handover complete message is sent, at S12.

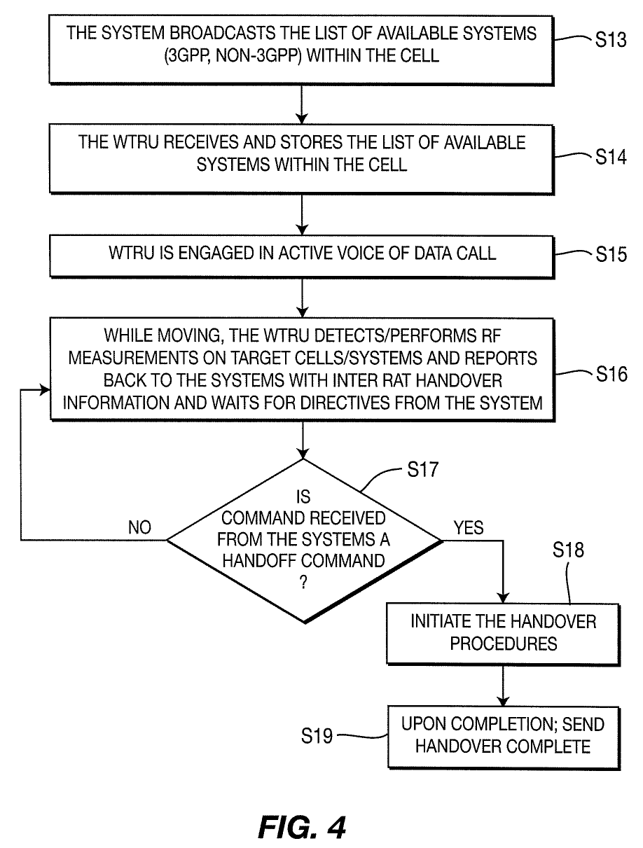

FIG. 4 is a flow diagram showing handoff procedures, which comprises an inter-RAT procedure for performing an inter-RAT handover. As shown in FIG. 4, a list of available systems is broadcast, at step S13, including information of Non-3GPP systems as well as 3GPP systems obtainable through the existing method of FIG. 2. The WTRU, at S14, receives and stores the list of available systems within the cell. While engaged in active voice of a data call, S15, and while moving, at S16, the WTRU detects and performs RF measurements on target cells/systems and, according to one embodiment, also reports inter-RAT handover information to the systems and then waits for directives. If a handoff command is received, at S17, handover procedures are initiated at S18 and, upon completion, a handover complete message is sent, at S19.

Proposed Modified Message Formats are set forth below:

Inter RAT Handover Information

This message, set forth below, is sent by the WTRU via another radio access technology to provide information to the target RNC when preparing for a handover to Other Systems from UTRAN.

RLC-SAP: N/A (Sent through a different RAT)

Logical channel: N/A (Sent through a different RAT)

Direction: WTRU→UTRAN

| Information | | | Type and | Semantics | |
|---|---|---|---|---|---|
| Element/Group Name | Need | Multi | reference | description | Version |
| Radio Bearer IEs | | | | | |
| Predefined | OP | | WiFi/WiMAX | | |
| configuration status | | | Predefined | | |
| information | | | configuration | | |
| | | | status | | |
| | | | information | | |
| Predefined | OP | | WiFi/WiMAX | | REL-8 |
| configuration status | | | Predefined | | |
| information compressed | | | configuration | | |
| | | | status | | |
| | | | information | | |
| | | | compressed | | |
| WTRU Information | | | | | |
| elements | | | | | |
| WTRU security | OP | | WTRU | | |
| information | | | security | | |
| | | | information: | | |
| | | | >WiMAX | | |
| | | | Protocol | | |
| | | | (Trusted) | | |
| | | | >WiFi | | |
| | | | Protocol | | |
| | | | (Non- | | |
| | | | Trusted) | | |
| | | | >WiFI | | |
| | | | Protocol | | |
| | | | (Trusted) | | |
| >WTRU Specific | OP | | WTRU | This IE shall not be | |
| Behaviour Information | | | Specific | included in this | |
| 1 interRAT | | | Behaviour | version of the | |
| | | | Information | protocol | |
| | | | 1 interRAT | | |
| | | | >WiMAX | | |
| | | | Protocol | | |
| | | | (Trusted) | | |
| | | | >WiFi | | |
| | | | Protocol | | |
| | | | (Non- | | |
| | | | Trusted) | | |
| | | | >WiFi | | |
| | | | Protocol | | |
| | | | (Trusted) | | |
| | | | >Fixed | | |
| | | | Broadband | | |
| WTRU capability | OP | | | | |
| container | | | | | |
| >WTRU radio access | MP | | WTRU radio | | |
| capability | | | access | | |
| | | | capability | | |
| | | | >WiMAX | | |
| | | | Protocol | | |
| | | | >WiFi | | |
| | | | Protocol | | |
| | | | >Fixed | | |
| | | | Broadbandl | | |

10.3.3.42 Modified WTRU Radio Access Capability

| Information Element/Group | | | Type and | Semantics | |
|---|---|---|---|---|---|
| name | Need | Multi | reference | description | Version |
| Access stratum release | MP | | Enumerate | Indicates the | |
| indicator | | | d(R99) | release of the | |
| | | | | WTRU | |
| | | | | according to | |
| | | | | [35]. The IE | |
| | | | | also indicates | |
| | | | | the release of | |
| | | | | the RRC | |
| | | | | transfer syntax | |
| | | | | supported by | |
| | | | | the WTRU.. | |
| | Code Value | | Enumerate | 13 spare values | REL-4 |
| | (CV)- | | d(REL-4, | are needed. | |
| | not_rrc_connectionSetup | | REL-5 | | REL-5 |
| | Complete | | REL-6) | | REL-6 |
| DL capability with | OP | | Enumerate | | REL-5 |
| simultaneous HS-DSCH | | | d(32 kbps, | | |
| configuration | | | 64 kbps, | | |
| | | | 128 kbps, | | |
| | | | 384 kbps) | | |
| PDCP capability | MP | | PDCP | | |
| | | | capability | | |
| | | | 10.3.3.24 | | |
| RLC capability | MP | | RLC | | |
| | | | capability | | |
| | | | 10.3.3.34 | | |
| Transport channel capability | MP | | Transport | | |
| | | | channel | | |
| | | | capability | | |
| | | | 10.3.3.40 | | |
| RF capability FDD | OP | | RF | | |
| | | | capability | | |
| | | | FDD | | |
| | | | 10.3.3.33 | | |
| RF capability WiFi | OP | | RF | | |
| | | | capability | | |
| | | | WiFi | | |
| RF capability WiMAX | OP | | RF | | |
| | | | capability | | |
| | | | WiMAX | | |
| RF capability Fixed Broadband | OP | | RF | | |
| | | | capability | | |
| | | | Broadband | | |
| RF capability TDD | OP | | RF | One “TDD RF | |
| | | | capability | capability” | |
| | | | TDD | entity shall be | |
| | | | 10.3.3.33b | included for | |
| | | | | every Chip rate | |
| | | | | capability | |
| | | | | supported. | |
| | | 1 to 2 | | | REL-4 |
| Physical channel capability | MP | | Physical | | |
| | | | channel | | |
| | | | capability | | |
| | | | 10.3.3.25 | | |
| WTRU multi-mode/multi-RAT | MP | | WTRU | | |
| capability | | | multi- | | |
| | | | mode/multi- | | |
| | | | RAT | | |
| | | | capability | | |
| Security capability | MP | | Security | | |
| | | | capability | | |
| | | | >WiMAX | | |
| | | | Protocol | | |
| | | | (Trusted) | | |
| | | | >WiFi | | |
| | | | Protocol | | |
| | | | (Non- | | |
| | | | Trusted) | | |
| | | | >WiFi | | |
| | | | Protocol | | |
| | | | (Trusted) | | |
| | | | >Fixed | | |
| | | | Broadband | | |
| WTRU positioning capability | MP | | WTRU | | |
| | | | positioning | | |
| | | | capability | | |
| | | | >WiMAX | | |
| | | | >WiFi | | |
| | | | >Fixed | | |
| | | | Broadband | | |
| Measurement capability | CH- | | Measurement | | |
| | fdd_req_sup | | capability | | |
| | | | >WiMAX | | |
| | | | >WiFi | | |
| | | | >Fixed | | |
| | | | Broadband | | |

Modified WTRU Multi-Mode/Multi-RAT Capability

| Information | | | Type and | Semantics | |
|---|---|---|---|---|---|
| Element/Group name | Need | Multi | Reference | description | Version |
| Multi-RAT capability | | | | | |
| Support of GSM | MP | | Boolean | | |
| Support of multi-carrier | MP | | Boolean | | |
| Multi-mode capability | MP | | Enumerated | | |
| | | | (TDD, FDD, | | |
| | | | FDD/TDD) | | |
| Support Non-3GPP WiMAX | MP | | Boolean | | |
| Support Non-3GPP WiFi | MP | | Boolean | | |
| Support Non-3GPP Fixed | MP | | Boolean | | |
| Broadband | | | | | |
| Support of UTRAN to | CV- | | Boolean | | REL-5 |
| GERAN NACC | not_iRAT_HoInfo | | | | |

Although the features and elements are described in the preferred embodiments in particular combinations, each feature or element can be used alone without the other features and elements of the preferred embodiments or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for a wireless transmitter/receiver unit (WTRU), the method comprising:
camping on a Third Generation Partnership Project (3GPP) channel in a cell;
receiving first information relating to the cell;
camping on a 3GPP network; and
requesting second information from the 3GPP network regarding networks in the cell other than 3GPP networks.

2. The method of claim 1 further comprising:
receiving the second information regarding at least one network accessible by the WTRU and which is not a 3GPP network.

3. The method of claim 1, wherein the second information is a cell information list.

4. The method of claim 1, wherein the list includes information regarding at least one wireless local area network (WLAN).

5. The method of claim 4, wherein the WLAN is a trusted 802.11 network.

6. The method of claim 4, wherein the list includes information regarding WLAN selection and reselection.

7. The method of claim 4, wherein the list includes at least one of Service Set Identifier (SSID) and operator information.

8. The method of claim 4, wherein the list includes system specific measurement information.

9. The method of claim 8, wherein the system specific measurement information relates to one of frequency, beacon and output power.

10. The method of claim 4, wherein the WLAN is a non-trusted 802.11 network.

11. The method of claim 10, wherein the list includes information regarding WLAN selection and reselection.

12. The method of claim 10, wherein the list includes at least one of Service Set Identifier (SSID) and operator information.

13. The method of claim 10, wherein the list includes system specific measurement information.

14. The method of claim 13, wherein the system specific measurement information relates to one of frequency, beacon and output power.

15. The method of claim 1, wherein the list includes information regarding at least one fixed broadband network.

16. The method of claim 15, wherein the list includes information regarding fixed broadband selection and reselection.

17. The method of claim 15, wherein the list includes operator information.

18. The method of claim 15, wherein the list includes system specific measurement information.

19. The method of claim 18, wherein the system specific measurement information relates to at least one of frequency, beacon and output power.

20. The method of claim 4, wherein the list includes trusted WiMAX network information.

21. The method of claim 20 wherein the list includes selection and re-selection information.

22. The method of claim 20, wherein the list includes one of service set identifier (SSID) and operator information.

23. The method of claim 20, wherein the cell information list includes system specific measurement information.

24. The method of claim 23 wherein the system specific measurement information includes at least one of frequency, beacon, and output power.

25. A method for a wireless transmitter/receiver unit (WTRU) to perform an inter radio access technology (inter-RAT) handover, the method comprising the steps of:
(a) receiving and storing a list including at least one available system within a cell;
(b) obtaining radio frequency (RF) measurements of at least one of a target cell and a system;
(c) reporting inter-RAT handover information to at least one of the systems;
(d) performing a handover responsive to a handoff command; and
(e) sending a handover complete message responsive to handover completion.

26. The method of claim 25 wherein step (d) further comprises performing the handoff to a universal terrestrial radio access network (UTRAN) system from another system.

27. The method of claim 26 wherein the UTRAN is an Evolved UTRAN (E-UTRAN).

28. The method of claim 27 wherein the said another system is a non-third generation partnership project (non-3GPP) system.

29. The method of claim 25 wherein step (d) further comprises performing the handoff from a universal terrestrial radio access network (UTRAN) system to another system.

30. The method of claim 29 wherein the said another system is a non third generation partnership project (non-3GPP) system.

31. The method of claim 25 wherein the inter-RAT handover information is sent via another RAT to provide information to a target radio network controller (RNC) preparatory to a handover from one system to another system.

32. The method of claim 31 wherein one of the systems is a universal terrestrial radio access network (UTRAN) system.

33. The method of claim 32 wherein said UTRAN is an Evolved UTRAN (E-UTRAN).

34. The method of claim 31 wherein the said another system is a non-third generation partnership project (non-3GPP) system.

35. A wireless transmitter receiver unit (WTRU) for communicating with a plurality of systems, the WTRU:
being configured to receive a list of at least one available system;
being configured to store the list;
being configured to perform radio frequency (RF) measurements on at least one of a target cell and a system;
being configured to report inter radio access technology (RAT) handover information; and
being configured to initiate a handover responsive to a handoff command.

36. The WTRU of claim 35, being configured to obtain RF measurements from at least one of a universal terrestrial radio access network (UTRAN) system and a non third generation partnership project (non-3GPP) system.

37. The WTRU of claim 35, being configured to perform a handoff from the UTRAN system to the non-3GPP system.

38. The WTRU of claim 35, being configured to perform a handoff from the non-3GPP system to the UTRAN system.

39. The WTRU of claim 35 wherein the list further comprises cell information on at least one of intra-frequency, inter-frequency, and inter-radio access technology (RAT) cells.

40. The WTRU of claim 35, wherein the list further includes at least one of a system information block (SIB) type 11 message, an SIB type 12 message, and a MEASUREMENT CONTROL message.

41. The WTRU of claim 35, wherein the memory is cleared of the list at cell re-selection.

42. The WTRU of claim 35, wherein the memory is cleared when leaving a universal terrestrial radio access (UTRA) radio resource control (RRC) connected mode.

43. The WTRU of claim 35, wherein the memory is cleared when the WTRU is deactivated.

44. The WTRU of claim 35 wherein the memory is cleared responsive to selection of a new public land mobile network (PLMN).
